(19) United States
(12) Patent Application Publication
(10) Pub. No.: US 2024/0275928 A1
(43) Pub. Date: Aug. 15, 2024

(54) METHOD OF DISPLAYING IMAGE, PROJECTOR, AND NON-TRANSITORY COMPUTER-READABLE STORAGE MEDIUM STORING PROGRAM

(71) Applicant: SEIKO EPSON CORPORATION, Tokyo (JP)

(72) Inventor: Kazumi SUZUKI, Matsumoto-shi (JP)

(73) Assignee: SEIKO EPSON CORPORATION, Tokyo (JP)

(21) Appl. No.: 18/439,509

(22) Filed: Feb. 12, 2024

(30) Foreign Application Priority Data
Feb. 13, 2023 (JP) 2023-020107

(51) Int. Cl. H04N 9/31

(52) U.S. Cl. CPC H04N 9/3185

(57) ABSTRACT

A method of displaying an image includes displaying an initial pattern image representing two or more control points to be used for shape correction of a projection image of a projector, receiving a first operation of moving a first control point as one of the two or more control points from a first position to a second position, displaying a first image representing the first control point before the movement at the first position when the first operation is received, and displaying a second image representing the first control point after the movement at the second position when the first operation is received.

The present application is based on, and claims priority from JP Application Serial Number 2023-020107, filed Feb. 13, 2023, the disclosure of which is hereby incorporated by reference herein in its entirety.

### BACKGROUND

### 1. Technical Field

The present disclosure relates to a method of displaying an image, a projector, and a non-transitory computer-readable storage device storing a program.

### 2. Related Art

In the past, there has been known a technology related to shape correction for projectors.

In, for example, JP-A-2019-125955 (Document 1), there is described the following content. In order for the user to accurately perform a movement of a correction target point by an operation on an operation terminal when executing geometric correction of the projector, a marker corresponding to an end point selected as the correction target point is displayed at the end point in a projection image and an end point on a pointing screen of the operation terminal.

In the technology described in Document 1, it is possible to confirm a position of a correction point after the movement, but it is unachievable to confirm a position of the correction point before the movement. Therefore, there is a room for improvement in convenience of the user.

### SUMMARY

An aspect of the present disclosure is a method of displaying an image including displaying a control point image representing two or more control points to be used for shape correction of a projection image of a projector, receiving a first operation of moving a first control point as one of the two or more control points from a first position to a second position, displaying a first image representing the first control point before the movement at the first position when the first operation is received, and displaying a second image representing the first control point after the movement at the second position when the first operation is received.

Another aspect of the present disclosure is a non-transitory computer-readable storage medium storing a program configured to make a processor execute displaying a control point image representing two or more control points to be used for shape correction of a projection image of a projector, receiving a first operation of moving a first control point as one of the two or more control points from a first position to a second position, displaying a first image representing the first control point before the movement at the first position when the first operation is received, and displaying a second image representing the first control point after the movement at the second position when the first operation is received.

Still another aspect of the present disclosure is a projector including an optical device, an input device configured to receive an operation of a user, and at least one processor, wherein the at least one processor is configured to execute making the optical device display a control point image representing two or more control points to be used for shape correction of a projection image of the projector, receiving, via the input device, a first operation of moving a first control point as one of the two or more control points from a first position to a second position, making the optical device display a first image representing the first control point before the movement at the first position when the first operation is received, and making the optical device display a second image representing the first control point after the movement at the second position when the first operation is received.

### BRIEF DESCRIPTION OF THE DRAWINGS

FIG. 1 is a diagram showing an example of a configuration of an image projection system according to an embodiment.

FIG. 2 is a diagram showing an example of a configuration of a projector according to the embodiment.

FIG. 3 is a diagram showing an example of a configuration of a first controller of the projector.

FIG. 4 is a diagram showing an example of a configuration of a control device.

FIG. 5 is a diagram showing an example of a transition of a projection image.

FIG. 6 is a flowchart showing an example of processing in a second controller of the control device.

### DESCRIPTION OF EMBODIMENTS

An embodiment will hereinafter be described with reference to the drawings.

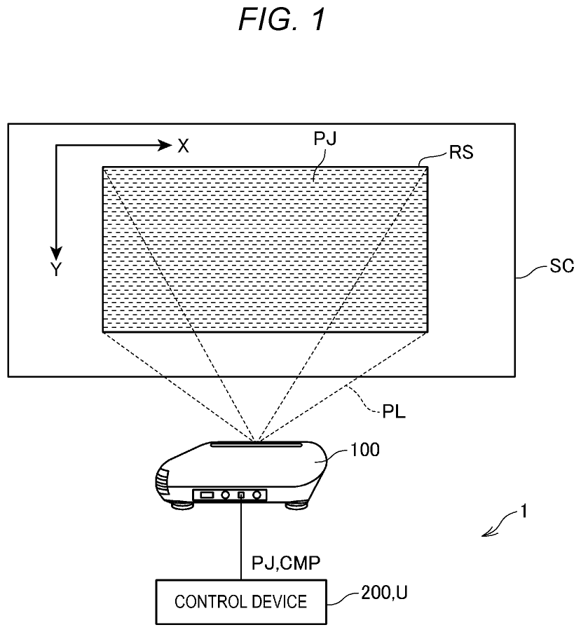

FIG. 1 is a diagram showing an example of a configuration of an image projection system 1 according to the present embodiment.

The image projection system 1 is provided with a projector 100 and a control device 200.

The control device 200 is configured with, for example, a personal computer, and instructs the projector 100 to project a projection image PJ. The control device 200 generates the projection image PJ based on an operation from a user U, and transmits the projection image PJ thus generated to the projector 100 via, for example, an Ethernet (a registered trademark) cable to make the projector 100 project the projection image PJ. The projection image PJ includes an initial pattern image PTA, a first pattern image PT1, a second pattern image PT2, and a third pattern image PT3.

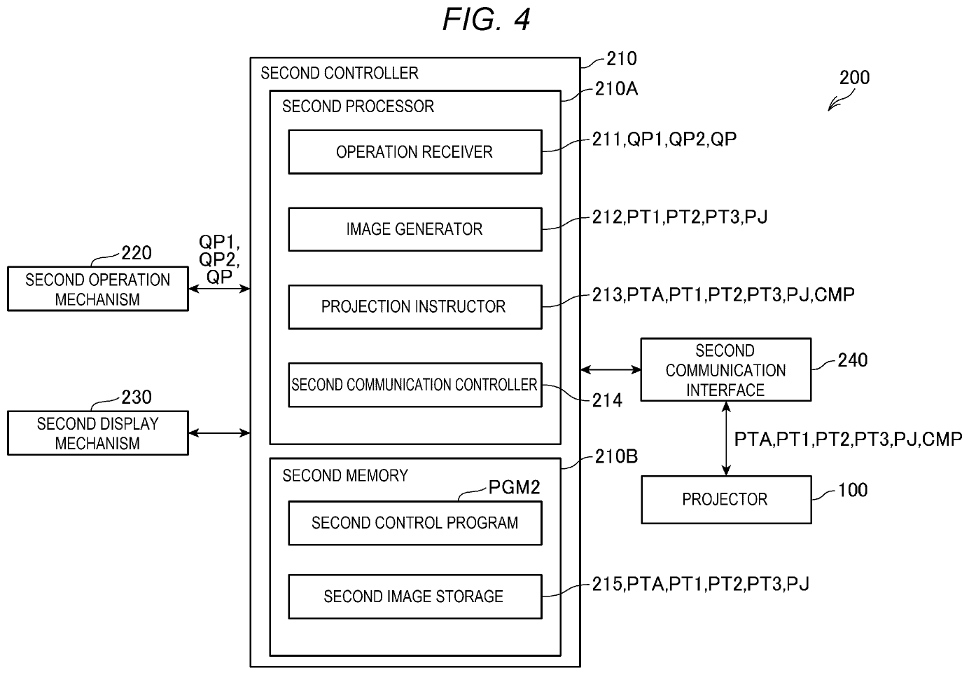

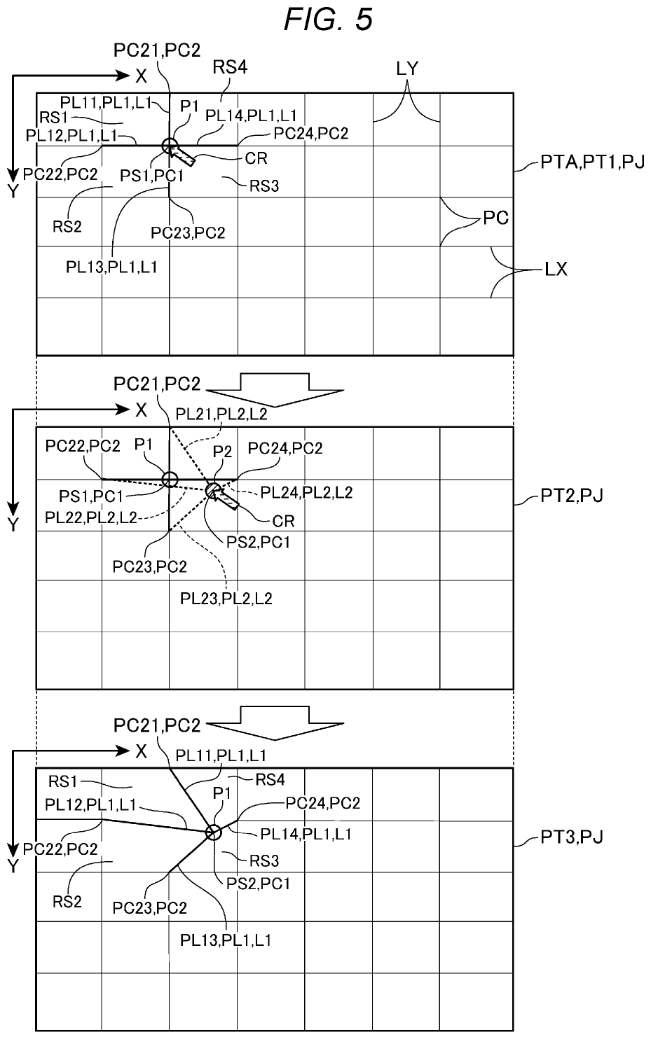

The initial pattern image PTA, and the first pattern image PT1 through the third pattern image PT3 will further be described with reference to FIG. 4 and FIG. 5.

The control device 200 transmits each of the first pattern image PT1 through the third pattern image PT3, and a command CMP to the projector 100. The command CMP instructs the projector 100 to update the projection image PJ. For example, when the projector 100 receives the second pattern image PT2 and the command CMP in the state in which the projector 100 displays the first pattern image PT1, the projector 100 projects the second pattern image PT2 instead of the first pattern image PT1.

The control device 200 is connected to the projector 100 so as to be able to perform wire communication with the Ethernet (the registered trademark) cable or the like in the present embodiment, but can be connected so as to be able to perform wireless communication with Wi-Fi (a registered trademark) or the like.

The control device 200 is configured with the personal computer in the present embodiment, but the control device 200 can be configured with a tablet terminal, a smartphone, or the like.

The projector 100 projects image light PL on a projection area RS of a screen SC. Further, the projector 100 projects the image light PL so as to display the projection image PJ on the screen SC.

In the screen SC in FIG. 1, there are shown an X axis and a Y axis perpendicular to each other. In FIG. 1, when the user stands toward the screen SC, the X axis represents a horizontal direction, and the Y axis represents a vertical direction. A positive direction of the X axis represents a rightward direction, and a positive direction of the Y axis represents a downward direction.

Further, in FIG. 5, there are shown the X axis and the Y axis.

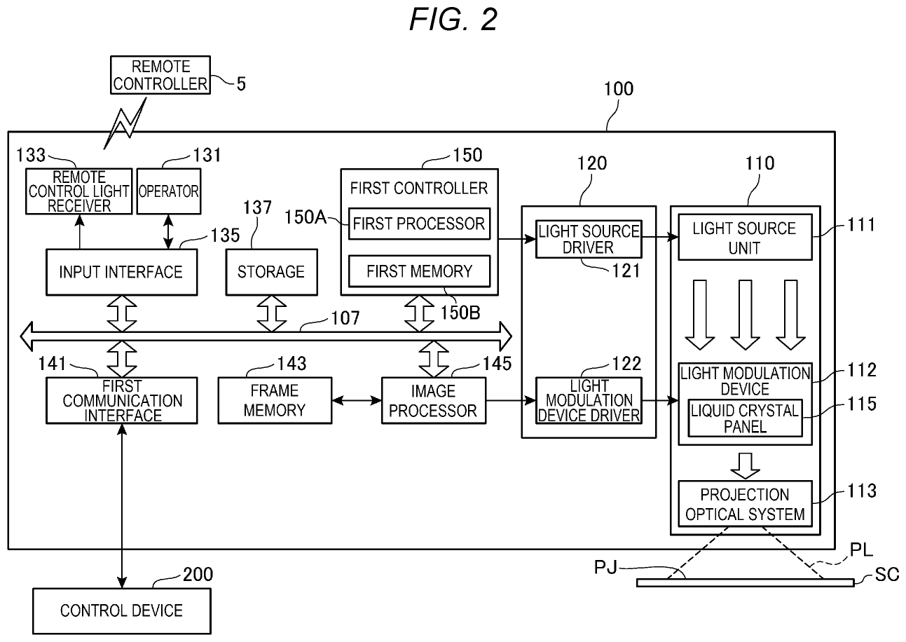

FIG. 2 is a diagram showing an example of a configuration of the projector 100 according to the present embodiment.

As shown in FIG. 2, the projector 100 is provided with a projection unit 110 and a driver 120 for driving the projection unit 110. The projection unit 110 performs formation of an optical image to project the image light PL on the screen SC. It should be noted that in the present embodiment, the projection unit 110 projects the image light PL corresponding to the projection image PJ on the screen SC. Further, in the present embodiment, the projection unit 110 projects the image light PL corresponding to a control point image representing two or more control points PC to be used for the shape correction of the projection image PJ on the screen SC. The number of the control points PC is, for example, 24 (=4×6) as explained with reference to FIG. 5.

The control point image represents the two or more control points PC to be used for so-called “point correction.” The “point correction” means correcting a distortion of the projection image PJ by adjusting positions of the respective intersections obtained by separating the projection image PJ into a grid. The intersections correspond respectively to the two or more control points PC.

The projection unit 110 is provided with a light source unit 111, a light modulation device 112, and a projection optical system 113. The driver 120 is provided with a light source driver 121 and a light modulation device driver 122.

The projection unit 110 corresponds to an example of an “optical device.”

The light source unit 111 is provided with a light source. The light source is a solid-state light source such as an LED (Light Emitting Diode) or a laser source.

In the present embodiment, there is described when the light source of the light source unit 111 is a solid-state light source, but this is not a limitation. The light source of the light source unit 111 can be a lamp light source such as a halogen lamp, a xenon lamp, or a super high-pressure mercury lamp.

Further, the light source unit 111 can also be provided with a reflector for guiding the light emitted by the light source to the light modulation device 112, and an auxiliary reflector. Further, the light source unit 111 can also be provided with a lens group for improving the optical characteristics of the projection light, a polarization plate, a dimming element for reducing the light intensity of the light emitted by the light source on a path leading to the light modulation device 112, or the like.

The light source driver 121 is coupled to an internal bus 107, and puts the light source of the light source unit 111 on and off to control the output of the light source in accordance with an instruction of a first controller 150 coupled likewise to the internal bus 107.

The light modulation device 112 is provided with three liquid crystal panels 115 corresponding respectively to, for example, the three primary colors of R, G, and B. The character R represents red, the character G represents green, and the character B represents blue. In other words, the light modulation device 112 is provided with the liquid crystal panel 115 corresponding to an R colored light beam, the liquid crystal panel 115 corresponding to a G colored light beam, and the liquid crystal panel 115 corresponding to a B colored light beam.

The light emitted by the light source unit 111 is separated into colored light beams of the three colors of RGB, and the colored light beams respectively enter the corresponding liquid crystal panels 115. The three liquid crystal panels 115 are each a transmissive liquid crystal panel, and each modulate the light transmitted therethrough to generate the first image light beam PLA. The first image light beams PLA having been modulated while passing through the respective liquid crystal panels 115 are combined with each other by a combining optical system such as a cross dichroic prism, and are then emitted to the projection optical system 113.

There is described in the present embodiment when the light modulation device 112 is provided with the liquid crystal panels 115 of the transmissive type as light modulation elements, but this is not a limitation. The light modulation element can be a reflective liquid crystal panel, or can also be a digital micromirror device (Digital Micromirror Device).

The light modulation device 112 is driven by the light modulation device driver 122. The light modulation device driver 122 is coupled to an image processor 145.

To the light modulation device driver 122, there is input image data corresponding to the respective primary colors of R, G, and B from the image processor 145. The light modulation device driver 122 converts the image data input thereto into data signals suitable for the operations of the liquid crystal panels 115. The light modulation device driver 122 applies a voltage to each pixel of each of the liquid crystal panels 115 based on the data signal thus converted to thereby draw an image on each of the liquid crystal panels 115.

The projection optical system 113 is provided with a projection lens, a mirror, or the like for focusing the image light beam PL having entered the projection optical system 113 on the screen SC. Further, the projection optical system 113 is provided with a zoom mechanism for expanding or contracting the image to be projected on the screen SC, a focus adjustment mechanism for performing a focus adjustment, a lens shift mechanism for adjusting a projection direction of the image light beam PL, and so on.

The projector 100 is further provided with an operator 131, a remote control light receiver 133, an input interface 135, a storage 137, a first communication interface 141, a frame memory 143, the image processor 145, and the first controller 150. The input interface 135, the storage 137, the first communication interface 141, the image processor 145, and the first controller 150 are connected to each other via the internal bus 107 so as to be able to achieve data communication with each other.

The operator 131 is provided with a variety of buttons and switches disposed on a surface of a chassis of the projector 100, and generates an operation signal corresponding to an operation performed on these buttons and switches to output the operation signal to the input interface 135. The input interface 135 is provided with a circuit for outputting the operation signal input from the operator 131, to the first controller 150.

The operator 131 corresponds to an example of an “input device.”

The remote control light receiver 133 receives an infrared signal transmitted from a remote controller 5, and then decodes the infrared signal thus received to generate the operation signal. The remote control light receiver 133 outputs the operation signal thus generated to the input interface 135. The input interface 135 is provided with a circuit for outputting the operation signal input from the remote control light receiver 133, to the first controller 150.

The remote controller 5 corresponds to another example of an “input device.”

The storage 137 is a magnetic recording device such as an HDD (Hard Disk Drive), or a storage device using a semiconductor storage element such as a flash memory or an SSD (Solid State Drive). The storage 137 stores a program to be executed by the first controller 150, data having been processed by the first controller 150, the image data, and so on.

The first communication interface 141 is a communication interface for performing the communication with the control device 200 in compliance with the Ethernet (the registered trademark) standard. The first communication interface 141 is provided with a connector to which the Ethernet (the registered trademark) cable is coupled, and an interface circuit for processing a signal transmitted through the connector. The first communication interface 141 is an interface board having the connector and the interface circuit, and is coupled to a main board on which a first processor 150A and so on of the first controller 150 are mounted. Alternatively, the connector and the interface circuit constituting the first communication interface 141 are mounted on the main board of the first controller 150. The first communication interface 141 receives the image data and so on from the control device 200.

The first controller 150 is provided with a first memory 150B and the first processor 150A.

The first memory 150B is a storage device for storing programs to be executed by the first processor 150A and data in a nonvolatile manner. The first memory 150B is formed of a magnetic storage device, a semiconductor storage element such as a flash ROM (Read Only Memory), or a nonvolatile storage device of other types. Further, the first memory 150B can also include a RAM (Random Access Memory) constituting a work area for the first processor 150A. The first memory 150B stores data to be processed by the first controller 150, and a first control program PGM1 and so on to be executed by the first processor 150A.

The first processor 150A can be configured with a single processor, or it is also possible to adopt a configuration in which two or more processors function as the first processor 150A. The first processor 150A executes the first control program PGM1 to control each part of the projector 100. For example, an execution instruction of the image processing corresponding to the operation received by the operator 131 or the remote controller 5, and parameters to be used in the image processing are output by the first processor 150A to the image processor 145. The parameters include, for example, geometric correction parameters for correcting a geometric distortion of the image to be projected on the screen SC. Further, the first processor 150A controls the light source driver 121 to control lighting and extinction of the light source unit 111, and to adjust the output, namely the light intensity, of the light source unit 111.

The first processor 150A corresponds to an example of “at least one processor.”

The first processor 150A can also be formed of an SoC (System-on-Chip) integrated with a part or the whole of the first memory 150B and other circuits. Further, the first processor 150A can also be formed of a combination of a CPU (Central Processing Unit) for executing the program, and a DSP (Digital Signal Processor) for executing predetermined arithmetic processing. It is also possible to adopt a configuration in which all of the functions of the first processor 150A are implemented in the hardware, or it is also possible to configure all of the functions of the first processor 150A using a programmable device.

The image processor 145 and the frame memory 143 can be formed of, for example, an integrated circuit. The integrated circuit includes an LSI (Large-Scale Integration), an ASIC (Application Specific Integrated Circuit), and a PLD (Programmable Logic Device). The PLD includes, for example, an FPGA (Field-Programmable Gate Array). Further, it is also possible for an analog circuit to be included as a part of a configuration of the integrated circuit, or it is also possible to adopt a combination of the processor and the integrated circuit. The combination of the processor and the integrated circuit is called a micro-controller (MCU), an SoC (System-on-chip), a system LSI, a chip set, and so on.

The image processor 145 loads the image data input from the first communication interface 141 in the frame memory 143. The frame memory 143 is provided with two or more banks. Each of the banks has a storage capacity sufficient for the image data corresponding to one frame to be written therein. The frame memory 143 is formed of, for example, an SDRAM (Synchronous Dynamic Random Access Memory).

The image processor 145 performs image processing such as resolution conversion processing, resizing processing, correction of a distortion aberration, shape correction processing, digital zoom processing, and an adjustment of tint and luminance of the image, on the image data loaded in the frame memory 143.

Further, the image processor 145 generates a vertical sync signal obtained by converting an input frame frequency of a vertical sync signal into a drawing frequency. The vertical sync signal thus generated is referred to as an output sync signal. The image processor 145 outputs the output sync signal thus generated to the light modulation device driver 122.

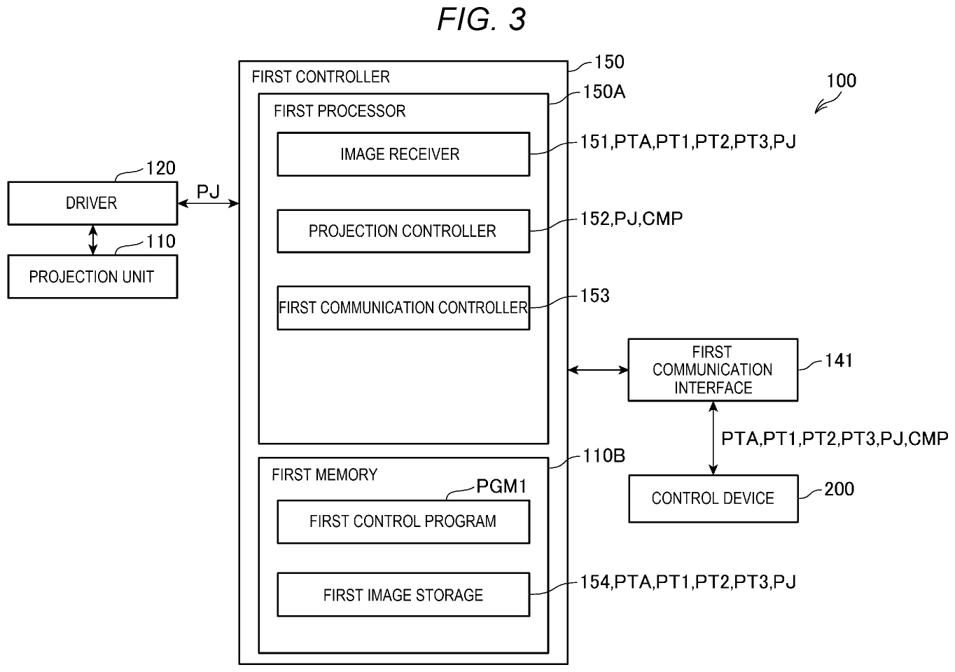

Then, a configuration of the first controller 150 of the projector 100 will be described with reference to FIG. 3. FIG. 3 is a diagram showing an example of the configuration of the first controller 150 of the projector 100. The first controller 150 of the projector 100 controls the operation of the projector 100 based on, for example, the instruction from the control device 200.

As shown in FIG. 3, the first controller 150 is provided with an image receiver 151, a projection controller 152, a first communication controller 153, and a first image storage 154. Specifically, the first processor 150A of the first controller 150 executes the first control program PGM1 stored in the first memory 150B to thereby function as the image receiver 151, the projection controller 152, and the first communication controller 153. Further, the first processor 150A of the first controller 150 executes the first control program PGM1 stored in the first memory 150B to thereby make the first memory 150B function as the first image storage 154.

The first image storage 154 stores the projection image PJ. The projection image PJ includes the initial pattern image PTA, and the first pattern image PT1 through the third pattern image PT3. The initial pattern image PTA, and the first pattern image PT1 through the third pattern image PT3 are received by the image receiver 151 from the control device 200, and are stored in the first image storage 154 by the image receiver 151.

The image receiver 151 receives the projection image PJ from the control device 200. The projection image PJ includes the initial pattern image PTA, and the first pattern image PT1 through the third pattern image PT3. The image receiver 151 makes the first image storage 154 store the projection image PJ thus received.

The projection controller 152 receives the command CMP from the control device 200. When the projection controller 152 receives the command CMP, the projection controller 152 projects the projection image PJ received by the image receiver 151 on the screen SC. For example, when the image receiver 151 has received the second pattern image PT2, and the projection controller 152 has received the command CMP in the state in which the projection controller 152 displays the first pattern image PT1, the projection controller 152 projects the second pattern image PT2 instead of the first pattern image PT1.

The first communication controller 153 receives the projection image PJ and the command CMP from the control device 200 via the first communication interface 141.

Then, a configuration of the control device 200 will be described with reference to FIG. 4. FIG. 4 is a diagram showing an example of the configuration of the control device 200. As shown in FIG. 4, the control device 200 is provided with a second controller 210, a second operation mechanism 220, a second display mechanism 230, and a second communication interface 240. The second controller 210 is provided with a second processor 210A and a second memory 210B. The second controller 210 controls an operation of each part of the control device 200.

Further, to the second controller 210, there are coupled the second operation mechanism 220, the second display mechanism 230, and the second communication interface 240.

To the second operation mechanism 220, there are coupled, for example, a mouse and a keyboard, and the second operation mechanism 220 receives an operation from the user U. The user U is, for example, a user of the control device 200. Then, the second operation mechanism 220 generates an operation signal corresponding to the operation thus received, and then outputs the operation signal thus generated to the second controller 210.

The second display mechanism 230 is provided with an LCD (Liquid Crystal Display) and so on, and displays a variety of images on the LCD in accordance with an instruction from the second controller 210.

The second communication interface 240 is provided with a connector and an interface circuit, and is coupled to the second controller 210. In the present embodiment, the second communication interface 240 is an interface for communicating with the projector 100 in compliance with, for example, the Ethernet (the registered trademark) standard.

The second processor 210A is formed of a CPU, a DSP, a microcomputer, or the like. The second processor 210A can be formed of two or more processors, or can also be formed of a single processor.

It is also possible for the second processor 210A to be hardware programmed so as to realize functions of elements described later. In other words, it is possible for the second processor 210A to have a configuration in which a second control program PGM2 is implemented as a hardware circuit. In this case, for example, the second processor 210A is formed of an ASIC, an FPGA, or the like.

In the following description, there is described when the second processor 210A executes the second control program PGM2 to thereby realize a variety of functions of the second controller 210.

The second processor 210A corresponds to an example of a “processor.”

The second memory 210B has a storage area for storing a program to be executed by the second processor 210A, and data to be processed by the second processor 210A. The second memory 210B stores the second control program PGM2 to be executed by the second processor 210A, and a variety of types of image data, setting data, and so on related to operations of the control device 200.

The second memory 210B has a nonvolatile storage area for storing the program and the data in a nonvolatile manner. The second memory 210B can be provided with, for example, a ROM, an HDD, and an SSD as the nonvolatile storage area. Further, it is possible for the second memory 210B to be provided with a volatile storage area, and to form a work area for temporarily storing the program to be executed by the second processor 210A and the data as the processing target. The second memory 210B can be provided with, for example, a RAM as the volatile storage area.

Further, as shown in FIG. 4, the second controller 210 is provided with an operation receiver 211, an image generator 212, a projection instructor 213, a second communication controller 214, and a second image storage 215. These elements are realized by cooperation of software and hardware by, for example, the second processor 210A executing the second control program PGM2.

The second control program PGM2 corresponds to an example of a “program.”

In the present embodiment, there is described when the control device 200 is provided with the operation receiver 211, the image generator 212, and the projection instructor 213, but this is not a limitation. For example, it is possible for the projector 100 to be provided with at least one of the operation receiver 211, the image generator 212, and the projection instructor 213.

For example, it is possible for the first processor 150A of the first controller 150 of the projector 100 to execute the first control program PGM1 to thereby function as the operation receiver 211, the image generator 212, and the projection instructor 213. In this case, the projector 100 is not required to be coupled to the control device 200 so as to be able to communicate with the control device 200. In other words, in the projector 100, the first controller 150 is provided with the operation receiver 211, the image generator 212, and the projection instructor 213 to thereby execute a “method of displaying an image” according to the present embodiment.

In order to distinguish the projector 100 in this case from the projector 100 according to the present embodiment, the projector 100 in this case is described as a projector 100A according to another embodiment in some cases in the following description.

In this case, the first control program PGM1 corresponds to an example of the “program.”

The second image storage 215 stores the projection image PJ. The projection image PJ includes the initial pattern image PTA, and the first pattern image PT1 through the third pattern image PT3. The initial pattern image PTA is stored in advance in the second image storage 215. The first pattern image PT1 through the third pattern image PT3 are generated by the image generator 212, and are stored in the second image storage 215 by the image generator 212. In the following description, the initial pattern image PTA, and the first pattern image PT1 through the third pattern image PT3 are described as the pattern image PT in some cases when not being distinguished from each other.

In the present embodiment, the initial pattern image PTA is a grid image. The initial pattern image PTA includes two or more line segments LX parallel to the X-axis direction, two or more line segments LY parallel to the Y-axis direction, and control points PC corresponding to the intersections of the two or more line segments LX and the two or more line segments LY.

The initial pattern image PTA corresponds to an example of a “control point image.”

Then, the initial pattern image PTA will further be described with reference to FIG. 5.

FIG. 5 is a diagram showing an example of a transition of the projection image PJ.

In an upper part of FIG. 5, there is described the initial pattern image PTA. In FIG. 5, the initial pattern image PTA includes six line segments LX, eight line segments LY, and 24 (=(6−2)×(8−2)) control points PC. The six line segments LX are arranged at regular intervals along the Y-axis direction. The eight line segments LY are arranged at regular intervals along the X-axis direction. The line segments LX and the line segments LY correspond to an example of an “image representing line segments.”

Going back again to FIG. 4, a configuration of the second controller 210 will be described.

The operation receiver 211 receives an operation QP from the user U. The operation QP includes a first operation QP1 and a second operation QP2. The user U performs the operation QP using, for example, the mouse of the second operation mechanism 220 with reference to the pattern image PT displayed on the LCD of the second display mechanism 230.

The first operation QP1 is the operation QP of moving a first control point PC1 from a first position PS1 to a second position PS2. The first control point PC1 is one of the two or more control points PC. The first operation QP1 is the operation QP of the user U clicking, for example, the first control point PC1 at the first position PS1, then dragging the first control point PC1 from the first position PS1 to the second position PS2, and then dropping the first control point PC1 at the second position PS2. In other words, the first operation QP1 is the operation QP of the user U performing a drag-and-drop operation from the first position PS1 to the second position PS2 on, for example, the first control point PC1.

The first control point PC1, the first position PS1, and the second position PS2 will further be described with reference to FIG. 5.

The second operation QP2 is the operation QP of fixing the position of the first control point PC1 to the second position PS2. The second operation QP2 is the operation QP of, for example, the user U holding down an Enter key of the keyboard of the second operation mechanism 220 after performing the first operation QP1. Further, the second operation QP2 can be the operation QP of, for example, the user U dropping the first control point PC1 at the second position PS2.

The image generator 212 generates the first pattern image PT1 through the third pattern image PT3 in accordance with the operation QP from the user U received by the operation receiver 211.

Further, the image generator 212 displays each of the initial pattern image PTA, and the first pattern image PT1 through the third pattern image PT3 on the LCD of the second display mechanism 230. For example, the image generator 212 first displays the initial pattern image PTA on the LCD of the second display mechanism 230. Then, when the first pattern image PT1 is generated, the image generator 212 displays the first pattern image PT1 thus generated on the LCD of the second display mechanism 230 instead of the initial pattern image PTA. Further, when the second pattern image PT2 is generated, the image generator 212 displays the second pattern image PT2 thus generated on the LCD of the second display mechanism 230 instead of the first pattern image PT1. Further, when the third pattern image PT3 is generated, the image generator 212 displays the third pattern image PT3 thus generated on the LCD of the second display mechanism 230 instead of the second pattern image PT2.

When the operation receiver 211 has received an operation of selecting the first control point PC1 at the first position PS1 such as clicking of the mouse on the first control point PC1 at the first position PS1 out of the first operation QP1, the image generator 212 generates the first pattern image PT1. The first pattern image PT1 includes a first image P1 representing the first control point PC1 before the movement. In other words, the first image P1 represents the first control point PC1 at the first position PS1.

The clicking of the mouse on the first control point PC1 corresponds to an example of an “operation of selecting the first control point at the first position.”

The first pattern image PT1 includes a first line segment image PL1 representing a first line segment L1 connecting the first control point PC1 at the first position PS1, and a second control point PC2 adjacent to the first control point PC1 out of the two or more control points PC to each other.

Specifically, the image generator 212 combines the first image P1 and the first line segment image PL1 with the initial pattern image PTA to thereby generate the first pattern image PT1.

Then, the first pattern image PT1 will further be described with reference to FIG. 5.

In the upper part of FIG. 5, there is described the first pattern image PT1. The first pattern image PT1 includes the first image P1. The first image P1 is, for example, an outline circle. The first image P1 represents the first control point PC1 before the movement. Regarding the first control point PC1, the control point PC located at an intersection of the second line segment LX from the top and the third line segment LY from the left is set as the first control point PC1 in FIG. 5. The intersection of the second line segment LX from the top and the third line segment LY from the left corresponds to the first position PS1.

In the upper part of FIG. 5, there is described a cursor CR when clicking by the mouse on the first control point PC1 at the first position PS1 is received. The cursor CR points the first control point PC1, namely the first position PS1.

As shown in the upper part of FIG. 5, the second control point PC2 includes, for example, a second control point PC21, a second control point PC22, a second control point PC23, and a second control point PC24. The second control point PC21 is located at a negative direction side of the Y axis with respect to the first control point PC1 at the first position PS1. The second control point PC22 is located at a negative direction side of the X axis with respect to the first control point PC1 at the first position PS1. The second control point PC23 is located at a positive direction side of the Y axis with respect to the first control point PC1 at the first position PS1. The second control point PC24 is located at a positive direction side of the X axis with respect to the first control point PC1 at the first position PS1.

As shown in the upper part of FIG. 5, the first line segment image PL1 includes, for example, a first line segment image PL11, a first line segment image PL12, a first line segment image PL13, and a first line segment image PL14. The first line segment image PL11 represents the first line segment L1 connecting the first control point PC1 at the first position PS1 and the second control point PC21 to each other. The first line segment image PL12 represents the first line segment L1 connecting the first control point PC1 at the first position PS1 and the second control point PC22 to each other. The first line segment image PL13 represents the first line segment L1 connecting the first control point PC1 at the first position PS1 and the second control point PC23 to each other. The first line segment image PL14 represents the first line segment L1 connecting the first control point PC1 at the first position PS1 and the second control point PC24 to each other.

In the upper part of FIG. 5, the first line segment image PL1 including the first line segment image PL11, the first line segment image PL12, the first line segment image PL13, and the first line segment image PL14 is represented by solid lines thicker than the line segments LX and the line segments LY in order to distinguish the first line segment image PL1 from the line segments LX and line segments LY. In other words, the first line segment image PL11, the first line segment image PL12, the first line segment image PL13, and the first line segment image PL14 are displayed in a display configuration different from that of other line segments LX, LY.

Going back again to FIG. 4, the configuration of the second controller 210 will be described.

When the operation receiver 211 has received the first operation QP1, the image generator 212 generates the second pattern image PT2. The second pattern image PT2 includes a second image P2 representing the first control point PC1 after the movement. In other words, the second image P2 represents the first control point PC1 at the second position PS2. Further, the image generator 212 makes the display configuration of the second image P2 different from the display configuration of the first image P1. For example, as shown in FIG. 5, the first image P1 is the outline circle, and the second image P2 is a circle with hatching.

Then, the second pattern image PT2 will further be described with reference to FIG. 5.

The second pattern image PT2 includes a second line segment image PL2 representing a second line segment L2 connecting the first control point PC1 at the second position PS2 and the second control point PC2 to each other.

Specifically, the image generator 212 combines the second image P2 and the second line segment image PL2 with the first pattern image PT1 to thereby generate the second pattern image PT2.

Further, the image generator 212 makes the display configuration of the second line segment image PL2 different from the display configuration of the first line segment image PL1. For example, the first line segment image PL1 is a solid line, and the second line segment image PL2 is a dotted line.

Then, the second pattern image PT2 will further be described with reference to FIG. 5.

In a middle part of FIG. 5, there is described the second pattern image PT2. The second pattern image PT2 includes the second image P2. The second image P2 represents the first control point PC1 at the second position PS2. The second position PS2 is located between the third line segment LY from the left and the fourth line segment LY from the left in the X-axis direction. Further, the second position PS2 is located between the second line segment LX from the top and the third line segment LX from the top in the Y-axis direction. The second image P2 is, for example, a circle with hatching.

As shown in the middle part of FIG. 5, the second control point PC2 includes, for example, the second control point PC21, the second control point PC22, the second control point PC23, and the second control point PC24. The second line segment image PL2 includes, for example, a second line segment image PL21, a second line segment image PL22, a second line segment image PL23, and a second line segment image PL24.

The second line segment image PL21 represents the second line segment L2 connecting the first control point PC1 at the second position PS2 and the second control point PC21 to each other. The second line segment image PL22 represents the second line segment L2 connecting the first control point PC1 at the second position PS2 and the second control point PC22 to each other. The second line segment image PL23 represents the second line segment L2 connecting the first control point PC1 at the second position PS2 and the second control point PC23 to each other. The second line segment image PL24 represents the second line segment L2 connecting the first control point PC1 at the second position PS2 and the second control point PC24 to each other.

In the middle part of FIG. 5, each of the second line segment image PL21, the second line segment image PL22, the second line segment image PL23, and the second line segment image PL24 is described with a dotted line.

Going back again to FIG. 4, the configuration of the second controller 210 will be described.

When the operation receiver 211 has received the second operation QP2, the image generator 212 generates the third pattern image PT3. The image generator 212 performs the following processing on, for example, the second pattern image PT2 to thereby generate the third pattern image PT3.

In other words, the image generator 212 displays the first image P1 at the second position PS2 instead of the second image P2 included in the second pattern image PT2. Further, the image generator 212 deletes the first image P1 displayed at the first position PS1 in the second pattern image PT2. The first image P1 represents the position of the first control point PC1. Displaying the first image Plat the second position PS2 represents that the position of the first control point PC1 is determined to be the second position PS2.

Further, the image generator 212 deletes the first line segment image PL1 included in the second pattern image PT2. Further, the image generator 212 changes the display configuration of the second line segment image PL2 included in the second pattern image PT2 to the display configuration of the first line segment image PL1 to form the first line segment image PL1.

Then, the third pattern image PT3 will further be described with reference to FIG. 5.

As shown in a lower part of FIG. 5, the third pattern image PT3 includes the first image P1 disposed at the second position PS2. Further, the third pattern image PT3 includes the first line segment image PL1.

The first line segment image PL1 includes, for example, the first line segment image PL11, the first line segment image PL12, the first line segment image PL13, and the first line segment image PL14. The first line segment image PL11 represents the first line segment L1 connecting the second control point PC1 at the second position PS2 and the second control point PC21 to each other. The first line segment image PL12 represents the first line segment L1 connecting the first control point PC1 at the second position PS2 and the second control point PC22 to each other. The first line segment image PL13 represents the first line segment L1 connecting the first control point PC1 at the second position PS2 and the second control point PC23 to each other. The first line segment image PL14 represents the first line segment L1 connecting the first control point PC1 at the second position PS2 and the second control point PC24 to each other.

As shown in the third pattern image PT3, since the position of the first control point PC1 is determined to be the second position PS2, a first image area RS1, a second image area RS2, a third image area RS3, and a fourth image area RS4 arranged around the first control point PC1 are deformed.

The first image area RS1 represents an area at an upper left side of the first control point PC1. The second image area RS2 represents an area at a lower left side of the first control point PC1. The third image area RS3 represents an area at a lower right side of the first control point PC1. The fourth image area RS4 represents an area at an upper right side of the first control point PC1.

It should be noted that in the third pattern image PT3 shown in the lower part of FIG. 5, in order to make the shapes of the first image area RS1 through the fourth image area RS4 eye-friendly, description of some of the line segments LX and some of the line segments LY is omitted.

Going back again to FIG. 4, the configuration of the second controller 210 will be described.

The projection instructor 213 makes the projector 100 sequentially project the initial pattern image PTA, the first pattern image PT1, the second pattern image PT2, and the third pattern image PT3.

The projection instructor 213 makes the projector 100 display the initial pattern image PTA when, for example, the projector 100 is powered on, and is coupled to the control device 200 so as to be able to communicate with each other. The projection instructor 213 retrieves the initial pattern image PTA from, for example, the second image storage 215, then associates the initial pattern image PTA with the command CMP, and then transmits the result to the projector 100. The command CMP instructs the projector 100 to project the image associated with the command CMP, namely the initial pattern image PTA.

When the image generator 212 generates the first pattern image PT1, the projection instructor 213 makes the projector 100 project the first pattern image PT1 thus generated instead of the initial pattern image PTA.

When the image generator 212 generates the first pattern image PT1, the projection instructor 213 associates, for example, the first pattern image PT1 thus generated with the command CMP, and then transmits the result to the projector 100. The command CMP instructs the projector 100 to project the image associated with the command CMP, namely the first pattern image PT1, instead of the initial pattern image PTA.

When the image generator 212 generates the second pattern image PT2, the projection instructor 213 makes the projector 100 project the second pattern image PT2 thus generated instead of the first pattern image PT1.

When the image generator 212 generates the second pattern image PT2, the projection instructor 213 associates, for example, the second pattern image PT2 thus generated with the command CMP, and then transmits the result to the projector 100. The command CMP instructs the projector 100 to project the image associated with the command CMP, namely the second pattern image PT2, instead of the first pattern image PT1.

When the image generator 212 generates the third pattern image PT3, the projection instructor 213 makes the projector 100 project the third pattern image PT3 thus generated instead of the second pattern image PT2.

When the image generator 212 generates the third pattern image PT3, the projection instructor 213 associates, for example, the third pattern image PT3 thus generated with the command CMP, and then transmits the result to the projector 100. The command CMP instructs the projector 100 to project the image associated with the command CMP, namely the third pattern image PT3, instead of the second pattern image PT2.

The second communication controller 214 transmits a variety of types of information to the projector 100 via the second communication interface 240.

The second communication controller 214 associates, for example, the initial pattern image PTA with the command CMP, and then transmits the result to the projector 100. Further, the second communication controller 214 associates, for example, the first pattern image PT1 with the command CMP, and then transmits the result to the projector 100. Further, the second communication controller 214 associates, for example, the second pattern image PT2 with the command CMP, and then transmits the result to the projector 100. Further, the second communication controller 214 associates, for example, the third pattern image PT3 with the command CMP, and then transmits the result to the projector 100.

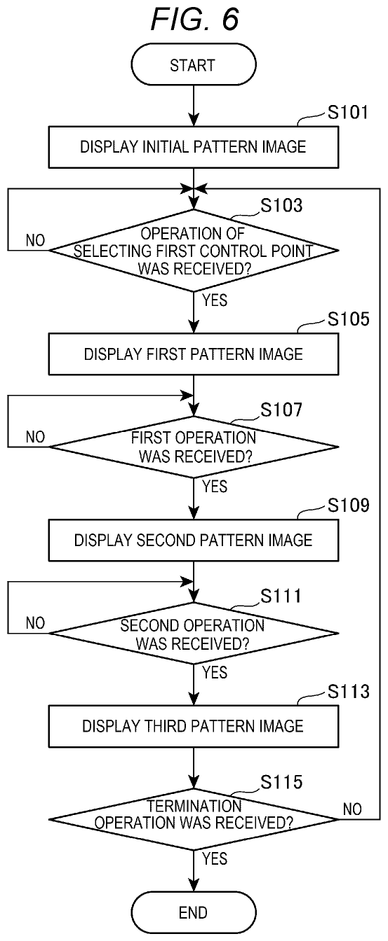

Then, processing of the second controller 210 of the control device 200 will be described with reference to FIG. 6. FIG. 6 is a flowchart showing an example of the processing of the second controller 210 of the control device 200.

As shown in FIG. 6, the projection instructor 213 first makes the projector 100 display the initial pattern image PTA in the step S101.

Then, in the step S103, the operation receiver 211 determines whether or not the operation of selecting the first control point PC1 at the first position PS1 out of the first operation QP1 has been received.

When the operation receiver 211 has determined that the operation of selecting the first control point PC1 at the first position PS1 has not been received (NO in the step S103), the process gets to a standby state. When the operation receiver 211 has determined that the operation of selecting the first control point PC1 at the first position PS1 has been received (YES in the step S103), the process proceeds to the step S105.

Then, in the step S105, the image generator 212 generates the first pattern image PT1, and then displays the first pattern image PT1 thus generated on the LCD of the second display mechanism 230 instead of the initial pattern image PTA. Further, the projection instructor 213 makes the projector 100 project the first pattern image PT1 instead of the initial pattern image PTA.

The first pattern image PT1 includes the first image P1 representing the first control point PC1 before the movement, and the first line segment image PL1. The first line segment image PL1 represents the first line segment L1 connecting the first control point PC1 before the movement, and the second control point PC2 adjacent to the first control point PC1 to each other.

Then, in the step S107, the operation receiver 211 determines whether or not the first operation QP1 has been received. The first operation QP1 is the operation QP of moving the first control point PC1 from the first position PS1 to the second position PS2.

When the operation receiver 211 has determined that the first operation QP1 has not been received (NO in the step S107), the process gets to the standby state. When the operation receiver 211 has determined that the first operation QP1 has been received (YES in the step S107), the process proceeds to the step S109.

Then, in the step S109, the image generator 212 generates the second pattern image PT2, and then displays the second pattern image PT2 thus generated on the LCD of the second display mechanism 230 instead of the first pattern image PT1. Further, the projection instructor 213 makes the projector 100 project the second pattern image PT2 instead of the first pattern image PT1.

The second pattern image PT2 includes the first image P1, the second image P2 representing the first control point PC1 after the movement, and the second line segment image PL2. The second line segment image PL2 represents the second line segment L2 connecting the first control point PC1 after the movement, and the second control point PC2 to each other.

Then, in the step S111, the operation receiver 211 determines whether or not the second operation QP2 has been received. The second operation QP2 is the operation QP of fixing the position of the first control point PC1 to the second position PS2.

When the operation receiver 211 has determined that the second operation QP2 has not been received (NO in the step S111), the process gets to the standby state. When the operation receiver 211 has determined that the second operation QP2 has been received (YES in the step S111), the process proceeds to the step S113.

Then, in the step S113, the image generator 212 generates the third pattern image PT3, and then displays the third pattern image PT3 thus generated on the LCD of the second display mechanism 230 instead of the second pattern image PT2. Further, the projection instructor 213 makes the projector 100 project the third pattern image PT3 instead of the second pattern image PT2.

The third pattern image PT3 includes the first image P1, and the first line segment image PL1. The first image P1 is disposed at the second position PS2 as the position of the first control point PC1 after the movement. The first line segment image PL1 is an image obtained by changing the display configuration of the second line segment image PL2 included in the second pattern image PT2 to the display configuration of the first line segment image PL1. The display configuration of the second line segment PL2 is, for example, a dotted line, and the display configuration of the first line segment image PL1 is, for example, a solid line. It should be noted that the third pattern image PT3 does not include the first image P1 at the first position PS1.

Then, in the step S115, the second controller 210 determines whether or not a termination operation has been received. The termination operation is an operation which is performed on the second operation mechanism 220 by the user U when terminating the “point correction.” The termination operation is, for example, a clicking operation by the mouse on a termination button representing the “termination of the point correction” displayed on the LCD of the second display mechanism 230. The termination button is displayed by the second controller 210 when, for example, the operation QP to the second operation mechanism 220 from the user U has not been received for a period equal to or longer than a predetermined period. The predetermined period is, for example, 20 seconds.

When the second controller 210 has determined that the termination operation has not been received (NO in the step S115), the process returns to the step S103. When the second controller 210 has determined that the termination operation has been received (YES in the step S115), the process is then terminated.

The step S101 corresponds to an example of “making a projector display a control point image.” The step S103 corresponds to an example of “receiving an operation of selecting a first control point at a first position.” The step S105 corresponds to an example of “displaying a first line segment image.” The step S107 corresponds to an example of “receiving a first operation.” The step S109 corresponds to an example of “making a projector display a first image at the first position, and display a second image at a second position,” and “displaying a second line segment image.” The step S111 corresponds to an example of “receiving a second operation.” The step S113 corresponds to an example of “displaying the first image at the second position instead of the second image,” and “deleting the first image displayed at the first position.”

As described with reference to FIG. 6, since the first pattern image PT1 is displayed when the operation of selecting the first control point PC1 at the first position PS1 has been received, it is possible for the user to confirm the fact that the first control point PC1 at the first position PS1 has been selected. Further, since the second pattern image PT2 including the second line segment image PL2 is displayed when the first operation QP1 has been received, it is possible for the user to visually recognize a deformation configuration of the areas arranged around the first control point PC1, namely the first image area RS1 through the fourth image area RS4 shown in FIG. 5, by the first operation QP1. Further, since the third pattern image PT3 including the first image P1 arranged at the second position PS2 is displayed when the second operation QP2 has been received, it is possible for the user to visually recognize the fact that the position of the first control point PC1 is fixed to the second position PS2.

### Functions and Advantages of Present Embodiment

As described hereinabove with reference to FIG. 1 through FIG. 6, the method of displaying an image according to the present embodiment includes displaying the initial pattern image PTA representing the two or more control points PC to be used for the shape correction of the projection image PJ of the projector 100, receiving the first operation QP1 of moving the first control point PC1 as one of the two or more control points PC from the first position PS1 to the second position PS2, displaying the first image P1 representing the first control point PC1 before the movement at the first position PS1 when the first operation QP1 is received, and displaying the second image P2 representing the first control point PC1 after the movement at the second position PS2 when the first operation QP1 is received.

In other words, when the first operation QP1 of moving the first control point PC1 as one of the two or more control points PC from the first position PS1 to the second position PS2 has been received, the first image P1 is displayed at the first position PS1, and the second image P2 is displayed at the second position PS2. The first image P1 represents the first control point PC1 before the movement. The second image P2 represents the first control point PC1 after the movement.

Therefore, since the first image P1 is displayed at the first position PS1, and the second image P2 is displayed at the second position PS2, it is possible for the user to visually recognize the position of the first control point PC1 before the movement in addition to the position of the first control point PC1 after the movement. Therefore, it is possible to enhance the convenience of the user.

Further, in the method of displaying an image described above, the displaying the first image P1 and the second image P2 includes making the display configuration of the second image P2 different from the display configuration of the first image P1.

Therefore, since the display configuration of the second image P2 is made different from the display configuration of the first image P1, it is possible for the user to easily distinguish the first image P1 and the second image P2 from each other. Therefore, it is possible to enhance the convenience of the user.

Further, in the method of displaying an image described above, there is further included displaying the first image P1 at the second position PS2 when the second operation QP2 of fixing the position of the first control point PC1 to the second position PS2 is received.

Therefore, since the first image P1 is displayed at the second position PS2 instead of the second image P2 when the second operation QP2 has been received, it is possible for the user to visually recognize the fact that the position of the first control point PC1 is fixed to the second position PS2. Therefore, it is possible to enhance the convenience of the user.

Further, in the method of displaying an image described above, there is further included deleting the first image P1 displayed at the first position PS1 when the second operation QP2 is received.

Therefore, since the first image P1 displayed at the first position PS1 is deleted when the second operation QP2 has been received, it is possible for the user to clearly and visually recognize the fact that the position of the first control point PC1 is fixed to the second position PS2. Therefore, it is possible to enhance the convenience of the user.

Further, in the method of displaying an image described above, there are further included displaying images LX, LY representing the line segments connecting the first control point PC1 at the first position P1 and the control points PC adjacent to the first control point PC1 out of the two or more control points PC to each other, and displaying the first line segment image PL1 which represents the first line segment L1 connecting the first control point PC1 at the first position PS1 and the second control point PC2 adjacent to the first control point PC1 out of the two or more control points PC to each other, and which is different in display configuration from the images LX, LY representing the line segments, when the operation QP of selecting the first control point PC1 at the first position PS1 out of the first operation QP1 is received.

Therefore, since the first line segment image PL1 is displayed when the operation QP of selecting the first control point PC1 at the first position PS1 has been received, it is possible for the user to visually recognize the shapes of the areas arranged around the first control point PC1. The areas arranged around the first control point PC1 correspond to, for example, the first image area RS1 through the fourth image area RS4 shown in FIG. 5. Therefore, it is possible to enhance the convenience of the user.

Further, in the method of displaying an image described above, there is further included displaying the second line segment image PL2 representing the second line segment L2 connecting the first control point PC1 at the second position PS2 and the second control point PC2 to each other when the first operation QP1 is received.

Therefore, since the second line segment image PL2 is displayed when the first operation QP1 has been received, it is possible for the user to visually recognize a change in shape of the area arranged around the first control point PC1 when the position of the first control point PC1 has been moved to the second position PS2. Therefore, it is possible to enhance the convenience of the user.

Further, in the method of displaying an image described above, the displaying the second line segment image PL2 includes making the display configuration of the second line segment image PL2 different from the display configuration of the first line segment image PL1.

Therefore, since the display configuration of the second line segment image PL2 is made different from the display configuration of the first line segment image PL1, it is possible for the user to easily distinguish the second line segment image PL2 and the first line segment image PL1 from each other. Therefore, it is possible to enhance the convenience of the user.

The second control program PGM2 according to the present embodiment makes the second processor 210A execute displaying the initial pattern image PTA representing the two or more control points PC to be used for the shape correction of the projection image PJ of the projector 100, receiving the first operation QP1 of moving the first control point PC1 as one of the two or more control points PC from the first position PS1 to the second position PS2, displaying the first image P1 representing the first control point PC1 before the movement at the first position PS1 when the first operation QP1 is received, and displaying the second image P2 representing the first control point PC1 after the movement at the second position PS2 when the first operation QP1 is received.

Therefore, it is possible for the second control program PGM2 according to the present embodiment to exert substantially the same advantages as those of the method of displaying an image according to the present embodiment.

The projector 100A according to another embodiment includes the projection unit 110, the operator 131 configured to receive the operation of the user, and the first processor 150A, wherein the first processor 150A executes making the projection unit 110 display the initial pattern image PTA representing the two or more control points PC to be used for the shape correction of the projection image PJ of the projector 100, receiving the first operation QP1 of moving the first control point PC1 as one of the two or more control points PC from the first position PS1 to the second position PS2 via the operator 131, making the projection unit 110 display the first image P1 representing the first control point PC1 before the movement at the first position PS1 when the first operation QP1 is received, and making the projection unit 110 display the second image P2 representing the first control point PC1 after the movement at the second position PS2 when the first operation QP1 is received.

Therefore, it is possible for the projector 100A according to another embodiment to exert substantially the same advantages as those of the method of displaying an image according to the present embodiment.

### Other Embodiments

The present embodiment described above is a preferred aspect of implementation. It should be noted that the present embodiment described above is not a limitation, but a variety of types of modified implementation are possible within the scope or the spirit thereof.

In the present embodiment, there is described when the control device 200 is provided with the operation receiver 211, the image generator 212, and the projection instructor 213, but this is not a limitation. For example, it is possible for the projector 100 to be provided with at least one of the operation receiver 211, the image generator 212, and the projection instructor 213.

For example, it is possible for the first processor 150A of the first controller 150 of the projector 100 to execute the first control program PGM1 to thereby function as the operation receiver 211, the image generator 212, and the projection instructor 213. In this case, the projector 100 is not required to be coupled to the control device 200 so as to be able to communicate with the control device 200. In other words, in the projector 100, the first controller 150 is provided with the operation receiver 211, the image generator 212, and the projection instructor 213 to thereby execute a “method of displaying an image” according to the present embodiment.

In order to distinguish the projector 100 in this case from the projector 100 according to the present embodiment, the projector 100 in this case is described as a projector 100A according to another embodiment in some cases.

Further, although there is not described when the control points PC include intersections of the two line segments LX constituting the outer edge of the initial pattern image PTA and the line segments LY in the present embodiment, substantially the same processing can be performed as when the intersections of the two line segments LX constituting the outer edge and the line segments LY are not included. When any one of the intersections of the two line segments LX constituting the outer edge of the initial pattern image PTA and the line segments LY is selected as the first control point PC1 in the first operation QP1, the first pattern image PT1 includes the first line segment image PL1 representing the first line segment L1 connecting the first control point PC1 and the second control point PC2 adjacent to the first control point PC1 out of the two or more control points PC to each other.

Specifically, the image generator 212 combines the first image P1 and the first line segment image PL1 with the initial pattern image PTA to thereby generate the first pattern image PT1.

Further, in the present embodiment, as shown in FIG. 5, there is described when the first image P1 is the outline circle, and the second image P2 is the circle with hatching, but this is not a limitation. It is sufficient to make the display configuration of the second image P2 different from the display configuration of the first image P1. The “display configuration” includes a color, a shape, and a pattern. For example, it is possible to make the color of the second image P2 different from the color of the first image P1. Specifically, it is possible to adopt a configuration in which the color of the second image P2 is red, and the color of the first image P1 is blue. Further, for example, it is possible to make the shape of the second image P2 different from the shape of the first image P1. Specifically, it is possible to adopt a configuration in which the shape of the second image P2 is a rectangular shape, and the shape of the first image P1 is a circular shape.

Further, in the present embodiment, there is described when the first line segment image PL1 is the solid line, and the second line segment image PL2 is the dotted line as shown in FIG. 5, but this is not a limitation. It is sufficient to make the display configuration of the second line segment image PL2 different from the display configuration of the first line segment image PL1. The “display configuration” includes a color, a line type, and a line thickness. For example, it is possible to make the color of the second line segment image PL2 different from the color of the first line segment image PL1. Specifically, it is possible to adopt a configuration in which the color of the second line segment image PL2 is red, and the color of the first line segment image PL1 is blue. Further, for example, it is possible to make the line thickness of the second line segment image PL2 different from the line thickness of the first line segment image PL1. Specifically, it is possible to adopt a configuration in which the line thickness of the second line segment image PL2 is thinner than the line thickness of the first line segment image PL1.

Further, each of the functional parts shown in FIG. 3 and FIG. 4 represents the functional configuration, and the specific implementation configuration is not particularly limited. In other words, it is not necessarily required to install the hardware individually corresponding to each of the functional parts, but it is possible to adopt a configuration of realizing the functions of the plurality of functional parts by a single processor executing a program. Further, a part of the function realized by software in the embodiment described above can also be realized by hardware, or a part of the function realized by hardware can also be realized by software. Besides the above, the specific detailed configuration of each part of the projector 100 and the control device 200 can arbitrarily be modified within the scope or the spirit of the present disclosure.

Further, the processing unit of the flowchart shown in FIG. 6 is obtained by dividing the processing of the second controller 210 of the control device 200 in accordance with major processing contents in order to make the processing of the second controller 210 easy to understand. The way of division or the names of the processing units shown in the flowchart in FIG. 6 are not limitations, and it is also possible to divide the processing into a larger number of processing units, or it is also possible to divide the processing so that one processing unit includes a larger amount of processing in accordance with the processing contents. Further, the processing sequence of the flowchart described above is not limited to the illustrated example.

Further, the method of displaying an image can be realized by making the second processor 210A provided to the control device 200 execute the second control program PGM2 corresponding to the method of displaying an image. Further, it is also possible to record the second control program PGM2 in advance on a recording medium which stores the second control program PGM2 in a computer-readable manner.

As the recording medium, there can be used a magnetic or optical recording medium, or a semiconductor memory device. Specifically, there can be cited a portable or rigid recording medium such as a flexible disk, an HDD, a CD-ROM (Compact Disc Read Only Memory), a DVD, a Blu-ray (registered trademark) disc, a magnetooptic disc, a flash memory, or a card-type recording medium. Further, the recording medium can also be a RAM, or a nonvolatile storage device such as a ROM or the HDD as an internal storage device provided to the control device 200.

It is possible to realize the method of displaying an image by storing the second control program PGM2 in advance in a server device or the like, and then downloading the second control program PGM2 from the server device to the control device 200.

Further, it is possible for the method of displaying an image to display each of the first pattern image PT1 through the third pattern image PT3 using a display device such as a monitor not shown coupled to the control device 200. In this case, the control device 200 is not required to transmit each of the first pattern image PT1 through the third pattern image PT3, and the command CMP to the projector 100.

### SUPPLEMENTARY NOTES

Hereinafter, the conclusion of the present disclosure will supplementarily be noted.

### Supplementary Note 1

A method of displaying an image including displaying a control point image representing two or more control points to be used for shape correction of a projection image of a projector, receiving a first operation of moving a first control point as one of the two or more control points from a first position to a second position, displaying a first image representing the first control point before the movement at the first position when the first operation is received, and displaying a second image representing the first control point after the movement at the second position when the first operation is received.

Thus, since the first image is displayed at the first position and the second image is displayed at the second position when the first operation is received, it is possible for the user to visually recognize the position of the first control point before the movement in addition to the position of the first control point after the movement. Therefore, it is possible to enhance the convenience of the user.

### Supplementary Note 2

The method of displaying an image described in Supplementary Note 1, wherein the displaying the first image and the second image includes making a display configuration of the second image different from a display configuration of the first image.

Thus, since the display configuration of the second image is made different from the display configuration of the first image, it is possible for the user to easily distinguish the first image and the second image from each other. Therefore, it is possible to enhance the convenience of the user.

### Supplementary Note 3

The method of displaying an image described in one of Supplementary Note 1 and Supplementary Note 2, further including displaying the first image at the second position when a second operation of fixing a position of the first control point to the second position is received.

Thus, since the first image is displayed at the second position when the second operation is received, it is possible for the user to visually recognize the fact that the position of the first control point is fixed to the second position. Therefore, it is possible to enhance the convenience of the user.

### Supplementary Note 4

The method of displaying an image described in Supplementary Note 3 further including deleting the first image displayed at the first position when the second operation is received.

Thus, since the first image displayed at the first position is deleted when the second operation is received, it is possible for the user to clearly and visually recognize the fact that the position of the first control point is fixed to the second position. Therefore, it is possible to enhance the convenience of the user.

### Supplementary Note 5

The method of displaying an image described in any one of Supplementary Note 1 through Supplementary Note 4, further including displaying an image representing a line segment connecting the first control point at the first position and a second control point adjacent to the first control point out of the two or more control points to each other, and displaying a first line segment image which represents a first line segment connecting the first control point at the first position and the second control point adjacent to the first control point out of the two or more control points to each other, and which is different in display configuration from the image representing the line segment, when an operation of selecting the first control point at the first position included in the first operation is received.

Thus, since the first line segment image is displayed when the operation of selecting the first control point at the first position is received, it is possible for the user to visually recognize the shape of the area arranged around the first control point. Therefore, it is possible to enhance the convenience of the user.

### Supplementary Note 6

The method of displaying an image described in Supplementary Note 5 further including displaying a second line segment image representing a second line segment connecting the first control point at the second position and the second control point to each other when the first operation is received.

Thus, since the second line segment image is displayed when the first operation is received, it is possible for the user to visually recognize a change in shape of the area arranged around the first control point when the position of the first control point has been moved to the second position. Therefore, it is possible to enhance the convenience of the user.

### Supplementary Note 7

The method of displaying an image described in Supplementary Note 6, wherein the displaying the second line segment image includes making a display configuration of the second line segment image different from a display configuration of the first line segment image.

Thus, since the display configuration of the second line segment image is made different from the display configuration of the first line segment image, it is possible for the user to easily distinguish the second line segment image and the first line segment image from each other. Therefore, it is possible to enhance the convenience of the user.

### Supplementary Note 8

A non-transitory computer-readable storage medium storing a program configured to make a processor execute displaying a control point image representing two or more control points to be used for shape correction of a projection image of a projector, receiving a first operation of moving a first control point as one of the two or more control points from a first position to a second position, displaying a first image representing the first control point before the movement at the first position when the first operation is received, and displaying a second image representing the first control point after the movement at the second position when the first operation is received.

Thus, the non-transitory computer-readable storage medium storing a program described in Supplementary Note 8 exerts substantially the same advantages as those of the method of displaying an image described in Supplementary Note 1.

### Supplementary Note 9

A projector including an optical device, an input device configured to receive an operation of a user, and at least one processor, wherein the at least one processor is configured to execute making the optical device display a control point image representing two or more control points to be used for shape correction of a projection image of the projector, receiving, via the input device, a first operation of moving a first control point as one of the two or more control points from a first position to a second position, making the optical device display a first image representing the first control point before the movement at the first position when the first operation is received, and making the optical device display a second image representing the first control point after the movement at the second position when the first operation is received.

Thus, the projector described in Supplementary Note 9 exerts substantially the same advantages as those of the method of displaying an image described in Supplementary Note 1.

What is claimed is:

1. A method of displaying an image comprising:
displaying a control point image representing two or more control points to be used for shape correction of a projection image of a projector;
receiving a first operation of moving a first control point as one of the two or more control points from a first position to a second position;
displaying a first image representing the first control point before the movement at the first position when the first operation is received; and
displaying a second image representing the first control point after the movement at the second position when the first operation is received.

2. The method of displaying an image according to claim 1, wherein
the displaying the first image and the second image includes making a display configuration of the second image different from a display configuration of the first image.

3. The method of displaying an image according to claim 2, further comprising:
displaying the first image at the second position when a second operation of fixing a position of the first control point to the second position is received.

4. The method of displaying an image according to claim 3, further comprising:
deleting the first image displayed at the first position when the second operation is received.

5. The method of displaying an image according to claim 1, further comprising:
displaying an image representing a line segment connecting the first control point at the first position and a second control point adjacent to the first control point out of the two or more control points to each other; and
displaying a first line segment image which represents a first line segment connecting the first control point at the first position and the second control point adjacent to the first control point out of the two or more control points to each other, and which is different in display configuration from the image representing the line segment, when an operation of selecting the first control point at the first position included in the first operation is received.

6. The method of displaying an image according to claim 5, further comprising:
displaying a second line segment image representing a second line segment connecting the first control point at the second position and the second control point to each other when the first operation is received.

7. The method of displaying an image according to claim 6, wherein
the displaying the second line segment image includes making a display configuration of the second line segment image different from a display configuration of the first line segment image.

8. A non-transitory computer-readable storage medium storing a program configured to make a processor execute processing comprising:
displaying a control point image representing two or more control points to be used for shape correction of a projection image of a projector;
receiving a first operation of moving a first control point as one of the two or more control points from a first position to a second position;
displaying a first image representing the first control point before the movement at the first position when the first operation is received; and
displaying a second image representing the first control point after the movement at the second position when the first operation is received.

9. A projector comprising:
an optical device;
an input device configured to receive an operation of a user; and
at least one processor, wherein
the at least one processor is configured to execute
making the optical device display a control point image representing two or more control points to be used for shape correction of a projection image of the projector,
receiving, via the input device, a first operation of moving a first control point as one of the two or more control points from a first position to a second position,
making the optical device display a first image representing the first control point before the movement at the first position when the first operation is received, and
making the optical device display a second image representing the first control point after the movement at the second position when the first operation is received.
